(19) United States
(12) Patent Application Publication
(10) Pub. No.: US 2023/0350963 A1
(43) Pub. Date: Nov. 2, 2023

(54) ITEM DISTRIBUTION AND SEARCH RANKING ACROSS LISTING PLATFORMS

(71) Applicant: ADOBE INC., San Jose, CA (US)

(72) Inventors: Michele Saad, Austin, TX (US); Matthew Cecil Zimmerman, Austin, TX (US)

(21) Appl. No.: 17/731,999

(22) Filed: Apr. 28, 2022

(51) Int. Cl. G06F 16/954; G06N 20/00; G06F 16/903; G06Q 30/06

(52) U.S. Cl. CPC G06F 16/954; G06N 20/00; G06F 16/90335; G06Q 30/0623

(57) ABSTRACT

A system leverages reinforcement learning techniques to determine distribution of items to listing platforms and search ranking rules for each listing platform. Using historical listing data regarding items listed at one or more listing platforms, a machine learning model generates item interaction data, and a reinforcement learning agent is initialized using the item interaction data. The reinforcement learning agent is trained to optimize a function for selecting item distributions and search ranking rules across listing platforms. At each epoch of a series of epochs, the function is used to select an action including a new distribution of items to listing platforms and new search ranking rules to use at each listing platform. After the action from an epoch is implemented, the reinforcement learning agent updates the function, for instance, based on an impact of the action.

### BACKGROUND

The past few decades have seen a paradigm shift away from “brick and mortar” stores toward online shopping. As a result, merchants now typically offer items via a variety of different online listing platforms. The listing platforms used by a given merchant can include, for instance, the merchant's own website offering the merchant's items, as well as any number of third-party e-commerce sites offering items from a variety of different merchants. Each of these listing platforms maintains a database storing information regarding available items and provides interfaces that enable users to access item information and otherwise interact with the listing platform, for instance, to purchase, rent, download, or stream items. Each listing platform also typically provides a search engine to facilitate users finding items on the listing platform.

### SUMMARY

Embodiments of the present invention relate to, among other things, a system that configures item distributions to listing platforms and search ranking rules used for items at the listing platforms. Using information regarding available items and historical listing data regarding those items at one or more listing platforms, the system uses a machine learning model to generate item interaction data that models pairwise interactions between items at a listing platform and their propensity to result in user interactions. The item interaction data is used to initialize a reinforcement learning agent. The reinforcement learning agent is trained via online learning to optimize a function for selecting item distributions to listing platforms and search ranking rules at each listing platform. At each epoch of a series of epochs, the function is used to select an action establishing a new item distribution and new search ranking rules. When the action is taken (e.g., the new item distribution and new search ranking rules implemented), the reinforcement learning agent updates the function, for instance, based on an impact of the action.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating an exemplary system in accordance with some implementations of the present disclosure;

FIG. 2 is a block diagram illustrating a system involving multiple listing platforms in accordance with some implementations of the present disclosure;

FIG. 3 is a schematic diagram showing an example operation of an item distribution and ranking system in accordance with some implementations of the present disclosure;

FIG. 4 is a diagram depicting a user interface for selecting search ranking rules in accordance with some implementations of the present disclosure;

FIG. 5 is a flow diagram showing a method for determining item distribution and search ranking rules across multiple listing platforms in accordance with some implementations of the present disclosure; and

FIG. 6 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “listing platform” comprises an electronic system providing information regarding items available for purchase, rent, download, and/or streaming by a user of a client device upon navigation to the listing platform. “Items” available at various listing platforms include physical products and digital content. Examples of listing platforms include e-commerce platforms, at which physical items are available for purchase, rental platforms at which physical items are available for rent (e.g., equipment, tools, real estate, vehicles, contract employees, etc.), and media platforms at which digital content is available for download/streaming. A listing platform includes a database for storing information regarding items available via the listing platform. The functionality of a listing platform includes provision of user interfaces (e.g., via a website or application) enabling surfacing of items to users interacting with the listing platform. Among other aspects, a listing platform provides a search engine that enables users to search for items stored in the database of the listing platform.

A “search ranking rule” refers to a rule layered over standard ranking rules of a search engine at a listing platform. Search ranking rules can be specified by an entity providing an item for listing on a listing platform. As examples to illustrate, a search ranking rule can dictate that ranking of a particular item is increased (e.g., “boosted”) or decreased (e.g., “buried”).

As used herein, an “item distribution” or “distribution of items” refers to a determination of which items (e.g., from a merchant's catalog) are listed on various listing platforms. An item distribution for a given item dictates which listing platform(s) store information regarding the item to make the item available via the listing platform.

As used herein, a “reinforcement learning agent” performing aspects of the technology described is carried out by hardware, firmware, and/or software to learn a “function” for determining item distributions to listing platforms and search ranking rules for items at each listing platform at any given time. Given a current state (e.g., a current item distribution and current search ranking rules), the “function” of the reinforcement learning agent selects a new state (e.g., a new item distribution and new search ranking rules). The reinforcement learning agent learns the function over a series of “epochs”. At each epoch, the function is used to select an action that is applied (e.g., a new item distribution and search ranking rules are applied at listing platforms), and the reinforcement learning agent updates the function using a reward determined based at least in part on the action taken.

“Historical listing data” comprises data collected from a listing platform. Among other things, historical listing data from a listing platform can include historical user behavior information, historical item availability, historical item similarity, and listing platform metadata. The historical user behavior information provides data on user interactions with items listed on each listing platform. This could include any user interaction with each item, such as, for instance, item views, length of time items are viewed, item purchases, etc. The listing platform metadata can include, for instance, whether the listing platform is the merchant's own platform (i.e., an internal platform) or a third party's platform (i.e., an external platform), a size of the listing platform, and a type of the listing platform (e.g., types of merchants offering items on the listing platform, types of products offered via the listing platform, etc.).

“Item interaction data” comprises data regarding pairwise interactions between listing items at a listing platform. In accordance with some aspects of the technology described herein, the item interaction data is generated by a machine learning model trained, at least in part, using historical listing data from one or more listing platforms.

### Overview

While listing platforms are incredibly useful tools for providing users access to items from merchants, shortcomings in existing technologies often result in the consumption of an unnecessary quantity of computing resources (e.g., storage, I/O costs, network packet generation costs, throughput, memory consumption, etc.). For instance, merchants often list items at multiple listing platforms. Because each listing platform maintains its own database of items listed by the platform, this requires redundant information for a given item to be stored at each of the listing platforms at which that item is offered. When merchants have catalogs with a large number of items, this can cause a correspondingly large consumption of storage.

Given the quantity of items available at some listing platforms and the variety of different listing platforms available, users often have to submit multiple queries before finding desired items. For example, a user can issue a first query to a search engine at a first listing platform that returns a set of search results. The user can browse the search results and select certain search results to access the corresponding items. Selection of items causes retrieval of the items from various content sources. Additionally, in some cases, applications supporting those items are launched in order to render the items. Often, the search results returned by the search engine don't satisfy the user's goal, requiring the user to spend more time on the search process by repeating the process of issuing additional queries and selecting certain search results until the user finally accesses a desired item or, in some cases, the user gives up because the search engine was not able to return desired search results even after multiple searches. If the user cannot find an item at a first listing platform, the user can try searching another listing platform, causing the above search process to be repeated.

These repetitive searches result in increased computing resource consumption, among other things. For instance, repetitive user queries result in packet generation costs that adversely affect computer network communications. Each time a user issues a query, the contents or payload of the query is typically supplemented with header information or other metadata within a packet in TCP/IP and other protocol networks. Accordingly, when this functionality is multiplied by all the inputs needed to obtain the desired data, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, repetitively issued queries is expensive because processing queries consumes a lot of computing resources. For example, for some search engines, a query execution plan can be calculated each time a query is issued, which requires a search system to find the least expensive query execution plan to fully execute the query. This decreases throughput and increases network latency, and can waste valuable time.

Aspects of the technology described herein improve the functioning of the computer itself in light of these shortcomings in existing technologies by providing a solution that concurrently optimizes: (1) item distribution among different listing platforms, and (2) search ranking rules used by search engines to rank items in response to search queries at each listing platform. In particular, some aspects are directed to a system that provides a dynamic approach for configuring item distributions and search ranking rules across multiple listing platforms at different points in time based on reinforcement learning strategies.

In accordance with some aspects of the technology described herein, the system leverages reinforcement learning techniques to solve an optimization problem that accounts for both item distribution across multiple listing platforms and the search ranking rules used to impact rankings of items at each listing platform. More particularly, online learning is used to train a reinforcement learning agent over a series of epochs to learn an optimized function for selecting item distributions and search ranking rules to implement at any given time. At each epoch, the reinforcement learning agent uses the function to select an action changing from a current item distribution and current search ranking rules to a new item distribution and new search ranking rules. The action is implemented, and the reinforcement learning agent updates the function. The function can be updated in response to a reward. The reward can be based on the action selected by the reinforcement learning agent. For instance, the action can result in changes that positively or negatively impact performance, such as key performance indicators (KPIs) at the listing platforms, user traffic to different listing platforms, and user interactions (e.g., views, purchases, etc.) with items listed at each listing platform. As such, the reward can be based on observed changes to such performance indicators.

While the reinforcement learning agent can be randomly initialized or initialized based on a best guess, in some aspects of the technology described herein, the reinforcement learning agent is initialized based on additional data. Initializing the reinforcement learning agent can include defining an initial function, initial item distribution, and/or initial search ranking rules. In some configurations, the reinforcement learning agent can be initialized based at least in part on search ranking rules selected by a merchant. In some configurations, the reinforcement learning agent can be initialized using item interaction data that models pairwise interactions between items at a listing platform and their propensity to result in a user interaction with each item. The item interaction data can be generated by a machine learning model trained on historical listing data from one or more listing platforms.

Aspects of the technology described herein provide a number of improvements over existing technologies. For instance, computing resource consumption is improved relative to existing technologies. In particular, optimizing the distribution of items to listing platforms prevents items from being listed at certain listing platforms when appropriate not to do so. This reduces the extent to which redundant data for an item is stored at different listing platforms, thereby conserving storage consumption. Additionally, optimizing distribution of items to listing platforms ensures that items are listed at certain listing platforms where appropriate to garner user interactions. This reduces the extent to which users need to perform the same queries at multiple listing platforms to find a particular item because the item is listed at a listing platform where users are more likely to search for and interact with the item. Optimizing search ranking rules also ensures that items are appropriately ranked based on the likelihood users are searching for particular items at a given listing platform. For instance, the search ranking rules can cause certain items to be boosted (i.e., ranked higher in search results) when users are more likely to be searching for the items, while other items are buried (i.e., ranked lower in search results) when users are less likely to be searching for the items.

Accordingly, optimization of item distribution and search ranking rules provided by aspects of the technology described herein eliminates (or at least reduces) the repetitive user queries, search result selections, and rendering of items. Accordingly, aspects of the technology described herein decrease computing resource consumption, such as packet generation costs. For instance, a user query (e.g., an HTTP request), would only need to traverse a computer network once (or fewer times relative to existing technologies). Specifically, the contents or payload of the user query is supplemented with header information or other metadata within a packet in TCP/IP and other protocol networks once for the initial user query. Such packet for a user query is only sent over the network once or fewer times. Thus, there is no repetitive generation of metadata and continuous sending of packets over a computer network. In like manner, aspects of the technology described herein improve storage device or disk I/O and query execution functionality, as they only need to go out to disk a single time (or fewer times relative to existing search technologies). As described above, the inadequacy of search results from existing technologies results in repetitive user queries, search result selections, and item renderings. This causes multiple traversals to disk. In contrast, aspects described herein reduce storage device I/O because the user provides only minimal inputs and so the computing system does not have to reach out to the storage device as often to perform a read or write operation. Accordingly, there is not as much wear on components, such as a read/write head, because disk I/O is substantially reduced. Various configurations also improve query execution resource savings. Specifically, for example, the search system calculates a query execution plan on fewer queries relative to existing search technologies. This increases throughput and decreases network latency because aspects of the technology described herein do not have to repetitively calculate query execution plans because fewer user queries need to be executed, unlike existing technologies.

### Example System for Item Distribution and Search Ranking

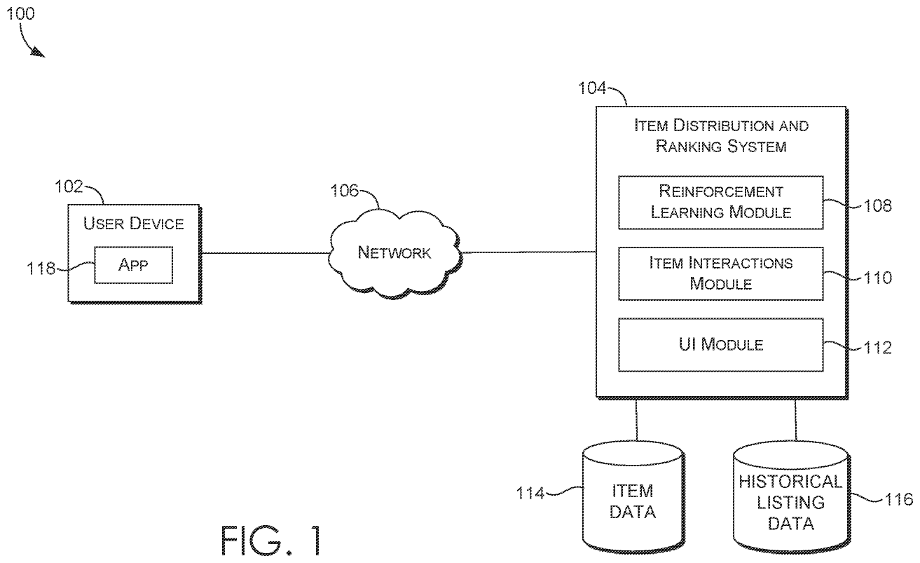

With reference now to the drawings, FIG. 1 is a block diagram illustrating an exemplary system 100 for item distribution and search ranking across multiple listing platforms in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

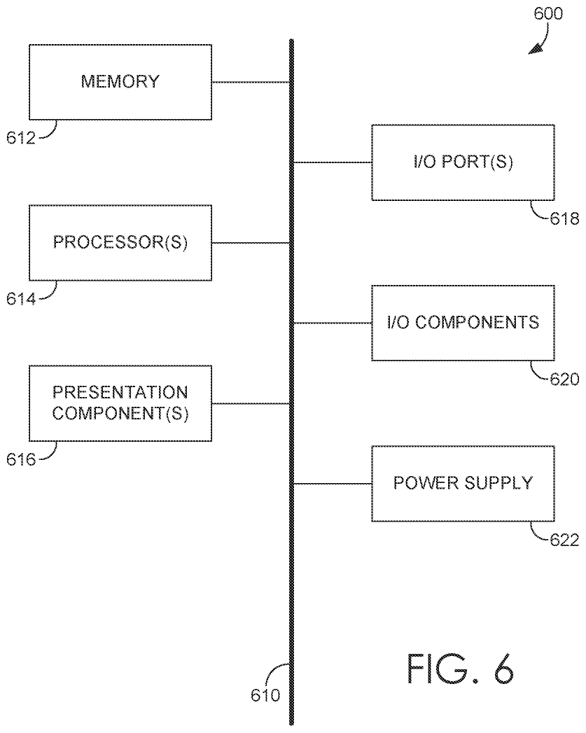

The system 100 is an example of a suitable architecture for implementing certain aspects of the present disclosure. Among other components not shown, the system 100 includes a user device 102 and an item distribution and ranking system 104. Each of the user device 102 and item distribution and ranking system 104 shown in FIG. 1 can comprise one or more computer devices, such as the computing device 600 of FIG. 6, discussed below. As shown in FIG. 1, the user device 102 and item distribution and ranking system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and item distribution and ranking systems can be employed within the system 100 within the scope of the present invention. Each can comprise a single device or multiple devices cooperating in a distributed environment. For instance, the item distribution and ranking system 104 could be provided by multiple devices collectively providing the functionality of the item distribution and ranking system 104 as described herein. Additionally, other components not shown can also be included within the network environment.

At a high level, the item distribution and ranking system 104 generates an optimized set of strategies for distributing items among various listing platforms and defining search ranking rules for items at each listing platform. As shown in FIG. 1, the item distribution and ranking system 104 includes a reinforcement learning module 108, item interactions module 110, and user interface module 112. These components can be in addition to other components that provide further additional functions beyond the features described herein.

The item distribution and ranking system 104 can be implemented using one or more devices, one or more platforms with corresponding application programming interfaces, cloud infrastructure, and the like. While the item distribution and ranking system 104 is shown separate from the user device 102 in the configuration of FIG. 1, it should be understood that in other configurations, some or all of the functions of the item distribution and ranking system 104 can be provided on the user device 102.

The reinforcement learning module 108 uses reinforcement learning to train a reinforcement learning agent to learn a function for concurrently determining item distributions across different listing platforms and search ranking rules to use at each listing problem at any given point in time. The problem of optimizing item distribution and search ranking rules across multiple listing platforms can be formulated as one unified optimization problem. Equation (1) below presents one way of summarizing an optimization problem to be solved by the item distribution and ranking system 104. As can be seen, Equation (1) accounts for both item distribution and search ranking across listing platforms simultaneously. It should be understood that Equation (1) is intended as an example of one approach to defining an optimization problem for item distribution and search ranking. Other ways of defining an optimization problem are possible and can be used.

$$\begin{matrix}max \\ {b}_{i} , {l}_{1 i} ∈ {Δ}_{1} , … {l}_{ni} ∈ {Δ}_{n}\end{matrix} {\sum }_{i = 1}^{N} {b}_{1 i} \{ {l}_{1 i} ∈ {Δ}_{1} \} + {c}_{1 i} + … + {\sum }_{i = 1}^{N} {b}_{ni} \{ {l}_{ni} ∈ {Δ}_{n} + {c}_{ni} \qquad ( 1 )$$

$$s . t . {b}_{i} ∈ \{ 0 , 1 \}$$

where n is the number of listing platforms, N is the number of items, bₘᵢ is a search ranking parameter for item i in listing platform m. bᵢ=0 means bury item i, and bᵢ=1 means boost item i. Δ₁, . . . Δₙ are the sets of items to be sold in each of the n listing platforms respectively and lₘᵢ is item i sold on listing platform m. cₘᵢ refers to the cost of selling item i in listing platform m.

Solving an optimization problem such as Equation (1) is combinatorically complex and difficult to solve empirically. As such, the reinforcement learning module 108 employs reinforcement learning techniques to solve this optimization problem in an online fashion. For instance, the reinforcement learning module 108 can employ a reinforcement learning online optimization approach, such as Markov Decision Processes (MDPs), although other approaches could be used. Online learning refers to the process of reaching an optimal solution incrementally and over time as the solution is deployed in the wild. This is different from solving the problem offline analytically and then implementing the resulting solution.

The reinforcement learning algorithm used by the reinforcement learning module 108 generally operates to train a learning agent to learn a function for selecting a distribution of items to listing platforms and search ranking rules at any given point in time. Item data 114 can provide information regarding items to be distributed among available listing platforms. This can include an entire catalog of items for a merchant or a portion thereof (e.g., a sub-catalog of items directed to a particular type of item).

The reinforcement learning algorithm can begin with initializing the reinforcement learning agent. This can include setting an initial function and/or initial item distribution and search ranking rules. In some instances, the reinforcement learning agent can be randomly initialized. In other instances, the reinforcement learning agent can be initialized based on, at least in part, initial search ranking rules selected by the merchant. In further instances, the reinforcement learning agent is initialized based at least in part on learned item interactions provided by the item interactions module 110, as will be described in further detail below.

After initializing the reinforcement learning agent, the reinforcement learning algorithm operates to train the reinforcement learning agent to learn an optimized function for selecting item distributions and search ranking rules at any given time. At each epoch, the reinforcement learning agent uses the current function to select an action given a current state. The state can include, for instance, a current distribution of items to listing platforms, current search ranking rules applied at each listing platform, previous states, and selected search ranking rules from the merchant. Given the current state, the function selects an action that includes a new distribution of items to listing platforms and search ranking rules to use for items at each listing platform. The action is applied (e.g., the new item distributions and new search ranking rules applied at each listing platform), a new state is observed, and a reward is given to the reinforcement learning agent, which updates the function based on the reward. The reward can be based on a variety of factors, such as for instance, key performance indicators (KPIs) determined for the listing platforms, user traffic to different listing platforms, and user interactions (e.g., views, purchases, etc.) with items listed at each listing platform. This process is repeated over any number of epochs to continue to optimize the function used by the reinforcement learning agent.

To improve upon the random or best guess initialization, the reinforcement learning module 108 can be seeded with item interaction data generated by the item interactions module 110 using historical listing data 116 from one or more listing platforms. The historical listing data 116 can include, for instance, historical user behavior information, historical item availability, historical item similarity, and listing platform metadata. The historical user behavior information provides data on user interactions with items listed on each listing platform. This could include any user interaction with each item, such as, for instance, item views, length of time items are viewed, item purchases, etc. The listing platform metadata can include, for instance, whether the listing platform is the merchant's own platform (i.e., an internal platform) or a third party's platform (i.e., an external platform), a size of the listing platform, and a type of the listing platform (e.g., types of merchants offering items on the listing platform, types of products offered via the listing platform, etc.).

The item interactions module 110 uses item data 114 and the historical listing data 116 to train a machine learning model to model the pairwise interaction between items and their correlations with the propensity to cause a user to purchase or otherwise interact with an item on a listing platform. Training the machine learning model begins with using the item data 114 and the historical listing data 116 to search for pairwise interactions between items on a listing platform. Similar training can be performed for each listing platform. Next, the pairwise interactions for the multiple listing platforms are analyzed to determine which pairwise interactions occur across multiple listing platforms. The analysis of the pairwise interactions can include determining weights for the pairwise interactions for use in calculating a fraction of the interactions between items. The output of the machine learning model comprises item interaction data regarding interactions between items. The pairwise interactions that occur across multiple listing platforms can then be used to seed the next epoch of the machine learning model.

The item distribution and ranking system 104 further includes a user interface module 112 that provides one or more user interfaces for a merchant to interact with the item distribution and ranking system 104. For instance, the user interface module 112 can provide user interfaces enabling a merchant to enter particular search ranking rules to influence the reinforcement learning process. The user interface module 112 can further provide user interfaces providing information regarding item distributions and search ranking rules determined by the reinforcement learning agent of the reinforcement learning module 108 at any given point in time.

The user device 102 can be any type of computing device, such as, for instance, a personal computer (PC), tablet computer, desktop computer, mobile device, or any other suitable device having one or more processors. As shown in FIG. 1, the user device 102 includes an application 118 for interacting with the item distribution and ranking system 104. The application 118 can be, for instance, a web browser or a dedicated application for interacting with the item distribution and ranking system 104. For instance, the application 118 can present user interfaces provided by the user interface module 112, allowing a merchant to enter search ranking rules and/or view item distributions and search ranking rules determined by the item distribution and ranking system 104.

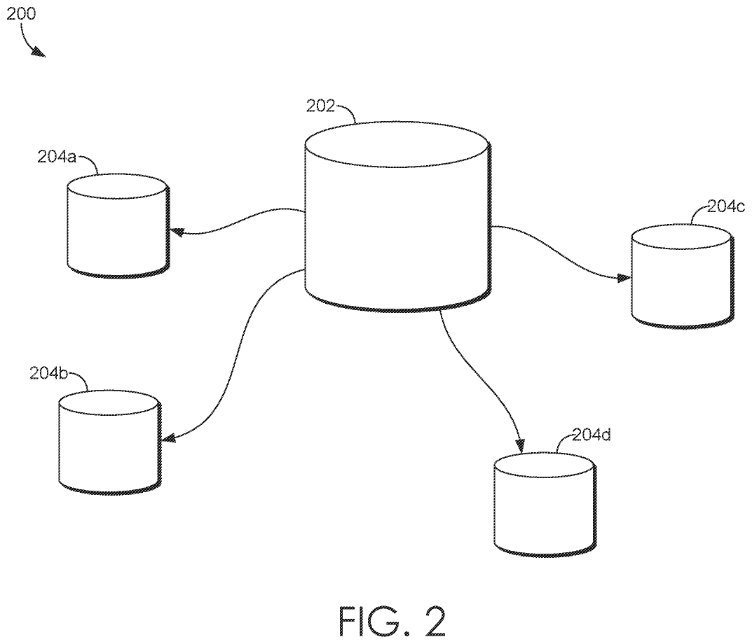

FIG. 2 is a block diagram of an overall system 200 involving multiple listing platforms, in accordance with some implementations described herein. The system 200 shows the relationship between a merchant system 202 and a group of listing platforms 204a-204d. The merchant system 202 includes an item distribution and ranking system (not shown) similar to the item distribution and ranking system 104 of FIG. 1. As such, the merchant system 202 determines item distribution among the listing platforms 204a-204d. Additionally, the merchant system 202 determines search ranking rules to use for items at each of the listing platforms 204a-204d. The merchant system 202 can vary the item distribution and search ranking rules across the listing platforms 204a-204d over time. The listing platforms 204a-204d can include, for instance, the merchant's own website, an e-commerce retailer platform that lists products from multiple merchants with many different types of products, a specialty craft platform focusing on particular types of products, and/or a major retailer website.

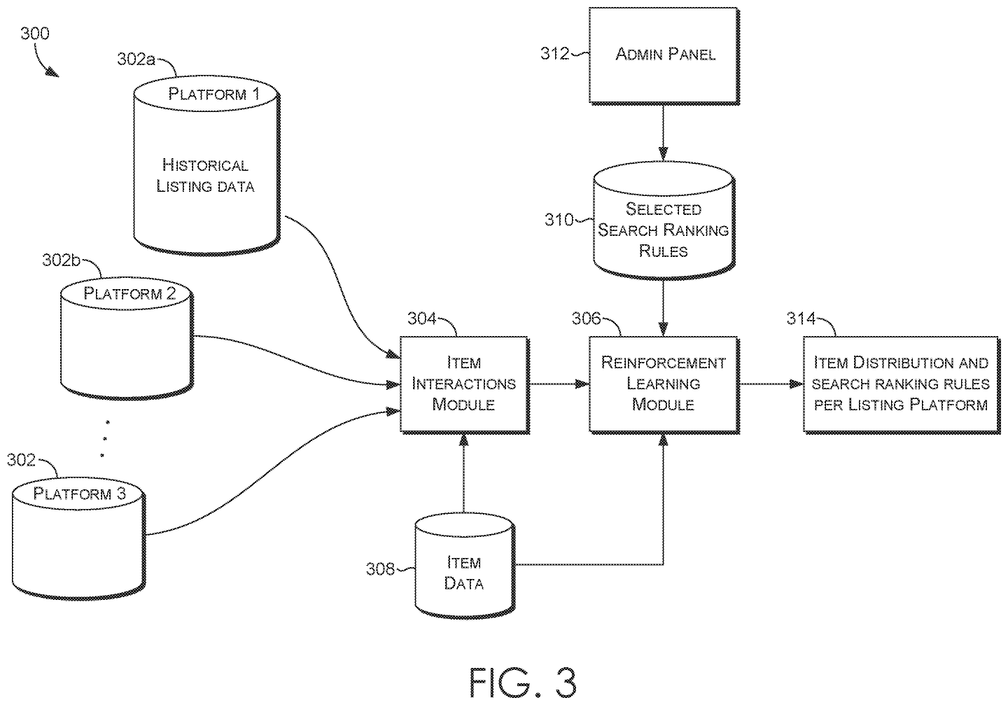

FIG. 3 is a schematic diagram showing operation 300 of an item distribution and ranking system, such as the item distribution and ranking system 104 of FIG. 1, to determine item distribution and search ranking rules across multiple listing platforms 302a-302n. These listings platforms 302a-302n could include, for instance, a combination of a merchant's own website, ecommerce retailer platforms, and retailer platforms. The process includes receiving historical listing data from each of the listing platforms 302a-302n. The historical listing data can include, among other things, historical user behavior information, historical item availability, historical item similarity, and listing platform metadata. The historical user behavior information provides data on user interactions with items listed on each listing platform. This could include any user interaction with each item, such as, for instance, item views, length of time items are viewed, item purchases, etc. The listing platform metadata can include, for instance, whether the listing platform is the merchant's own platform (i.e., an internal platform) or a third party's platform (i.e., an external platform), a size of the listing platform, and a type of the listing platform (e.g., types of merchants offering items on the listing platform, types of products offered via the listing platform, etc.).

The historical listing data from each of the listing platforms 302a-302n is input to an item interactions module 304 (which can be similar to the item interactions module 110 of FIG. 1), along with item data 308 from the merchant's catalog of items. The item interactions module 304 analyzes product interactions based on the historical listing data. More particularly, the item interactions module 304 models the pairwise interaction between items and their correlation with the propensity of a customer to make a purchase or otherwise interact with an item at a listing platform. The item interactions can include purchasing, saving for further review and consideration, and time viewed. The types of item interactions can be ranked in order to reflect the correlation between purchasing and interacting with items at a listing platform. Purchasing an item receives the highest correlation ranking, viewing an item for a particular period of time can receive a lower correlation ranking, and saving an item for further viewing on the listing platform receives a still lower correlation ranking. The item interactions data output by the item interactions module 304 seeds the reinforcement learning module 306. Seeding the reinforcement learning model can use the correlation ranking of the item interactions to determine which pairwise interactions are input to the reinforcement learning module 306.

The reinforcement learning module 306 learns how to optimize the distribution of items across listing platforms 302a-302n and search ranking rules to use at each listing platform 302a-302n in an online fashion. Online learning refers to the process of reaching an optimal solution incrementally and over time as the solution is deployed to distribute items to the listing platforms 302a-302n and set search ranking rules used at each listing platform 302a-302n. The reinforcement learning algorithm typically begins with an initial solution, which could be randomly chosen, or can be based on an expert guess. In some configurations, such as that shown in FIG. 3, the initial solution is based at least in part on the item interaction data from the item interactions module 304. The reinforcement learning algorithm learns an optimal solution dynamically as it learns from the online environment.

In some configurations such as that shown in FIG. 3, the reinforcement learning module 306 also receives input regarding search ranking rules 310 selected by the merchant. The search ranking rules 310 can be initially selected by the merchant via an administrative panel 312. For instance, the merchant can be given the option to define several search ranking rules via the administrative panel 312. This allows the merchant to specify potential search ranking rule strategies using the administrative panel. The selected search ranking rules 310 are used by the reinforcement learning module 306 (e.g., using the algorithm of Equation 1) to find an optimal set of search ranking rules per listing platform 302a-302n at any given point in time. The output of the reinforcement learning module 306 is an optimal distribution of items and search ranking rules 314 for each listing platform 302a-302n. The output can be used to control which items are listed at each of the listing platforms 302a-302n and to also set search ranking rules used for items at each of the listing platforms 302a-302n.

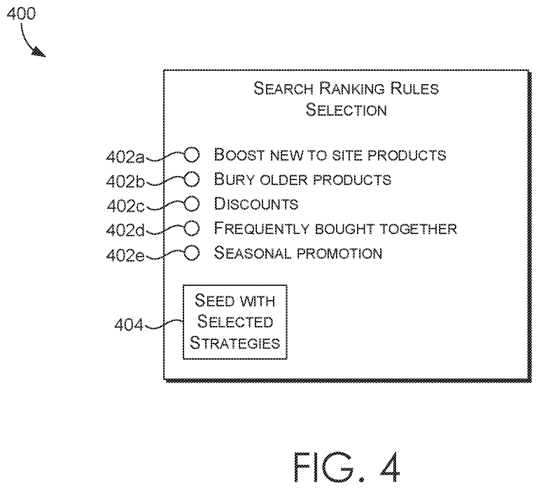

FIG. 4 depicts a user interface 400 that facilitates selection of search ranking rules by a merchant. The user interface 400 includes user interface elements for selecting from a variety of strategies for search ranking rules. The strategies can include buttons for: boost new to site products 402a, bury older products 402b, discounts 402c, frequently bought together 402d, and seasonal promotion 402e. Other strategies can be added to the screen and selection can be made by selecting a radio button, clicking on a box, or other screen selection method. Once a merchant has made the selections the strategies are seeded to a reinforcement learning module, such as the reinforcement learning module 108 of FIG. 1 or the reinforcement learning module 306 of FIG. 3.

### Example Methods for Item Distribution and Search Ranking

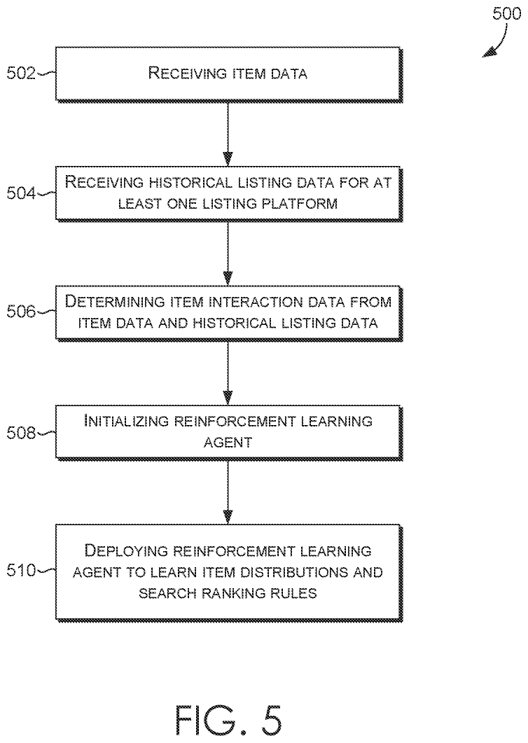

With reference now to FIG. 5, a flow diagram is provided that illustrates a method 500 for determining item distribution and search ranking rules across multiple listing platforms. The method 500 can be performed, for instance, by the item distribution and ranking system 104 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, item data is received. The item data includes information for items from the merchant's catalog. This can include all items or a portion of items offered by the merchant. For instance, the merchant's catalog can include multiple sub-catalogs, such as specialty sub-catalogs for special interests or customers. Any or all items from the merchant's catalog can be used as input.

Historical listing data from at least one listing platform is also received, as shown at block 504. The historical listing data can include, among other things, historical user behavior information, historical item availability, historical item similarity, and listing platform metadata. The historical user behavior information provides data on user interactions with items listed on each listing platform. This could include any user interaction with each item, such as, for instance, item views, length of time items are viewed, item purchases, etc. The listing platform metadata can include, for instance, whether the listing platform is the merchant's own platform (i.e., an internal platform) or a third party's platform (i.e., an external platform), a size of the listing platform, and a type of the listing platform (e.g., types of merchants offering items on the listing platform, types of products offered via the listing platform, etc.). .

At block 506, item interaction data is determined for items identified by the item data received at block 502. The item interaction data comprises inferences of item interactions at listing platforms determined using historical listing data received at block 504. The inferences are drawn from the behavior of items in the presence of other items at a listing platform. This recognizes that different items interact differently depending on the mix of items offered at a particular listing platform. The inferences of item interactions can be based on purchasing an item in conjunction with another item on the same listing platform at the same time, viewing an item on the same listing platform while having a first item in a shopping cart for purchase, the time the second item is viewed in conjunction with the first item, and also whether the item is saved in a section of the listing platform for further review. The item interactions can be determined using a pairwise interaction approach based on the various types of item interactions.

A learning agent is initialized, as shown at block 508. Initializing the reinforcement learning agent can include defining an initial function for selecting an item distribution and search ranking rules, an initial item distribution, and/or an initial set of search ranking rules. The initial item distribution can be based on a merchant's knowledge of prior sales, related items or activities, or a guess. A further option is a randomized selection by the reinforcement learning agent. Item data can include information about pairwise interactions, or which items have sold in conjunction with each other on a listing platform. In addition, item data can include the correlation ranking data discussed above, including purchase correlation rankings, viewing time correlation rankings, saving for further review correlations, and similar correlation ranking. The reinforcement learning agent is initialized using the item data received at block 502 and the item interaction data determined at block 508. Additionally, the reinforcement learning agent can be initialized using search ranking rules selected by the merchant.

As shown at block 510, the reinforcement learning agent is deployed to learn an optimal function for selecting item distributions among listing platforms and search ranking rules for each listing platform at any given time. The process includes adjusting the function over a number of epochs. At each epoch, the reinforcement learning agent uses the function to select an action given a current state, applies an item distribution and search ranking rules at the listing platforms based on the action, and updates the function given a reward. The reward can be based on, for instance, key performance indicators (KPIs) determined for the listing platforms, user traffic to different listing platforms, and user interactions (e.g., views, purchases, etc.) with items listed at each listing platform. This process is repeated over any number of epochs to continue to optimize the function used by the reinforcement learning agent.

### Exemplary Operating Environment

Having described implementations of the present disclosure, an exemplary operating environment in which embodiments of the present invention can be implemented is described below in order to provide a general context for various aspects of the present disclosure. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention can be practiced in a variety of system configurations, including hand-held devices, consumer electronics, general-purpose computers, more specialty computing devices, etc. The invention can also be practiced in distributed computing environments where tasks are performed by remote-processing devices that are linked through a communications network.

With reference to FIG. 6, computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what can be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory can be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which can be built in. Illustrative components include a microphone, joystick, game pad, satellite dish, scanner, printer, wireless device, etc. The I/O components 620 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 600. The computing device 600 can be equipped with depth cameras, such as, stereoscopic camera systems, infrared camera systems, RGB camera systems, and combinations of these for gesture detection and recognition. Additionally, the computing device 600 can be equipped with accelerometers or gyroscopes that enable detection of motion.

Aspects of the present invention have been described in relation to particular embodiments, which are intended in all respects to be illustrative rather than restrictive. Alternative embodiments will become apparent to those of ordinary skill in the art to which the present invention pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code.

Further, while embodiments of the present invention can generally refer to the technical solution environment and the schematics described herein, it is understood that the techniques described can be extended to other implementation contexts.

From the foregoing, it will be seen that this invention is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing instructions that, when used by one or more processors, cause the one or more processors to perform operations, the operations comprising:
determining, using a machine learning model, item interaction data using historical listing data for at least one listing platform from a plurality of listing platforms;
initializing a reinforcement learning agent using the item interaction data; and
deploying the reinforcement learning agent to use a function to select an action at each of a plurality of epochs and update the function at each epoch, the action selected by the function at each epoch changing a current distribution of items to each listing platform and current search ranking rules for each listing platform to a new distribution of items to each listing platform and new search ranking rules for each listing platform.

2. The computer storage media of claim 1, wherein the historical listing data for the at least one listing platform comprises historical user behavior information for the at least one listing platform, the historical user behavior information comprising at least one selected from the following: user views of items; time lengths of item views, and user purchases of items.

3. The computer storage media of claim 1, wherein the historical listing data for the at least one listing platform comprises metadata for the at least one listing platform, the metadata for the at least one listing platform comprising at least one selected from the following: whether the at least one listing platform is internal or external; a size of the at least one listing platform; and a type of the at least one listing platform.

4. The computer storage media of claim 1, wherein initializing the reinforcement learning agent using the item interaction data comprises using the item interaction data to set at least one selected from the following: an initial function, an initial distribution of items to each listing platform, and an initial search ranking rules for each listing platform.

5. The computer storage media of claim 1, wherein deploying the reinforcement learning agent comprises employing a Markov decision process to update the function over the plurality of epochs.

6. The computer storage media of claim 1, wherein a first new search ranking rule increases or decreases a ranking of a first item at a first listing platform from the plurality of listing platforms.

7. The computer storage media of claim 1, wherein the reinforcement learning agent is further initialized using one or more user-provided search ranking rules.

8. The computer storage media of claim 1, wherein the reinforcement learning agent adjusts the function at each epoch based at least in part on a reward provided in response to the action selected for the epoch.

9. The computer storage media of claim 8, wherein the reward is based on a key performance indicator.

10. A computer-implemented method comprising:
determining, by an item interaction module, item interaction data for at least one listing platform from a plurality of listing platforms;
initializing, by a reinforcement learning module, a reinforcement learning agent using the item interaction data; and
deploying, by the reinforcement learning module, the reinforcement learning agent to use a function, at each of a plurality of epochs, to determine a distribution of items to the plurality of listing platforms and search ranking rules for each listing platform.

11. The computer-implemented method of claim 10, wherein the item interaction data uses historical listing data for the at least one listing application.

12. The computer-implemented method of claim 10, wherein to determine a distribution of items to the plurality of listing platforms changes a current distribution of items of each listing platform.

13. The computer-implemented method of claim 12, further comprising changing current search ranking rules for each listing platform.

14. The computer-implemented method of claim 10, wherein the item interaction data comprises historical listing data for the at least one platform, the historical listing data comprising at least one of the following: user views of items, user purchase of items, time length of item views, and prior item placement in a cart by a same viewer.

15. The computer-implemented method of claim 13, further comprising increasing or decreasing a ranking of a first item based on the change in the current search ranking rules for each listing platform.

16. The computer-implemented method of claim 10, wherein the reinforcement learning agent is initialized using one or more user-provided search rules.

17. A system comprising:
a computer storage media; and
a processing device, operatively coupled to the one or more computer storage media, to perform operations comprising:
determining, using a machine learning model, item interaction data using historical listing data for at least one listing platform from a plurality of listing programs, wherein the machine learning model uses pairwise interactions of the items and determines weights for the pairwise interactions;
initializing, by a reinforcement learning module, a reinforcement learning agent using the item interaction data; and
deploying, by the reinforcement learning module, the reinforcement learning agent to select an action at each of a plurality of epochs and update the function at each epoch, the action selected by the function increasing or decreasing a current distribution of items to at least one listing platform.

18. The system of claim 17, wherein the weights for the pairwise interactions of the item interactions data are used to determine a fraction of the interactions between items for each listing platform.

19. The system of claim 18, further comprising determining which pairwise interactions of the item interactions occur across multiple listing platforms.

20. The system of claim 19, further comprising seeding a next epoch of the machine learning model with the pairwise interactions of the item interactions that occur across multiple listing platforms.
